(19) United States
(12) Patent Application Publication
(10) Pub. No.: US 2012/0110257 A1
(43) Pub. Date: May 3, 2012

(54) VIRTUAL TAPE DEVICE AND METHOD FOR SELECTING PHYSICAL TAPE

(75) Inventors: Katsuo ENOHARA, Kawasaki (JP); Shigeru SAKAMOTO, Kawasaki (JP); Fumio MATSUO, Kawasaki (JP)

(73) Assignee: FUJITSU LIMITED, Kawasaki-shi (JP)

(21) Appl. No.: 13/240,057

(22) Filed: Sep. 22, 2011

(30) Foreign Application Priority Data
Nov. 2, 2010 (JP) 2010-246905

(51) Int. Cl. G06F 12/00

(52) U.S. Cl. 711/111; 711/E12.001

(57) ABSTRACT

A virtual tape device being located between a host and a tape library and storing data as a virtual logical volume in a storage, has a calculator that calculates a time period in which a robot moves, from a cell to a drive device, the physical tape in accordance with an instruction when the instruction is issued to recall the target logical volume redundantly stored on the physical tapes stored in two or more cells included in different tape libraries or in the same tape library and to store the target logical volume, a calculator that calculates a time period for tape positioning, and a unit that calculates a time period on the basis of the time period in which the robot moves from the cell to the drive device and the time period for the tape positioning, and that selects a physical tape corresponding to the shortest time period.

### CROSS-REFERENCE TO RELATED APPLICATION

This application is based upon and claims the benefit of priority of the prior Japanese Patent Application No. 2010-246905, filed on Nov. 2, 2010, the entire contents of which are incorporated herein by reference.

### FIELD

The embodiments discussed herein are related to a virtual tape device and a method for selecting physical tape.

### BACKGROUND

A virtual tape device is a device that virtually performs a tape operation on a large-scale storage device such as a hard disk. Mechanical operations such as mounting of a tape and loading/unloading of the tape are eliminated by arranging tape image data as a logical volume (LV) in the large-scale storage device so that a high-speed process may be performed.

The virtual tape device is connected to a tape library device that is a back-end tape library device. As a device that converts data stored in the tape library device into a virtual volume, a redundant array of inexpensive disks (RAID) device is used, for example. The RAID device is a device that is operated as a single virtual hard disk by combining a plurality of hard disks. Reliability and an operational speed may be increased by the RAID device. In the virtual tape device, the RAID device is used as a tape volume cache (TVC). The TVC does not necessarily need to be constituted by the plurality of hard disks. The TVC may be constituted by a large-scale storage device such as a solid state drive (SSD) device. A tape volume (volume data) that is accessed from a host device is stored in the TVC. The volume data is called a logical volume. When an available space does not exist in the TVC, the most early accessed tape volume is deleted from the TVC by removing the most early accessed tape volume from the TVC and saving the most early accessed tape volume in a tape cartridge included in the tape library device. When access to the logical volume removed from the TVC occurs, a physical volume that corresponds to the logical volume is read from the tape library device into the TVC. An operation of reading the logical volume data removed from the TVC from a magnetic tape and reflecting the logical volume data in the TVC is called a recall.

The virtual tape device is defined as a normal tape device on an operating system (OS) of the host device and operates without regard to the tape library device.

In the tape library device, a plurality of tape cartridges are stored in a storage called a cell. When access to a logical volume that does not exist on the TVC occurs in the virtual tape device, the following operation is performed. That is, a robot that is a medium transport mechanism and is included in the tape library device transports, from the cell to a drive included in the tape library device, a tape cartridge in which a physical volume that corresponds to the logical volume is stored. Then, the data that is stored in the tape cartridge is loaded into the TVC.

The logical volume data that is to be written in accordance with an instruction provided from the host device is temporarily stored in the TVC. After that, the logical volume data is reflected in the physical tape (magnetic tape) included in the tape cartridge of the tape library device. A conventional tape library device that has a function (called a dual saving function) of writing the same data on two physical tapes is known. The dual saving function is a function that is provided to protect data from a failure of the tape cartridge or a failure of the tape library device by duplicating the data to be stored.

The data that is written in two different tape library devices by the dual saving function is unconditionally read (recalled) from a physical tape of a specific tape library device (first tape library device) among the two tape library devices.

Japanese Laid-open Patent Publication No. 2004-86251 is an example of the related art.

In the aforementioned case, the positions of sectors of data written on the physical tapes included in the two different tape library devices are different from each other in some cases. In addition, the positions of cells in which tape cartridges for the physical tapes are stored in the two different tape library devices are different from each other in some cases. Furthermore, the positions of robots that stop in the two tape library devices at the time of the recall are different from each other in some cases. Thus, the data may be recalled from the physical tape included in a second tape library device (among the tape library devices) for a shorter time than recalling of the same data from the physical tape included in the first tape library device in some cases.

There has been a case that an access efficiency is low in the recall process of reading the data from the physical tape only in order from the physical tape of the specific one of the tape library devices in some cases.

### SUMMARY

According to an aspect of an invention, a virtual tape device that is located between a host device and a tape library device and stores, as a virtual logical volume in a large-scale storage device, data that has been transmitted and is to be received between the host device and the tape library device, has a robot movement time period calculator that calculates, for each of physical tapes on which a target logical volume to be recalled exists, a time period in which a robot moves, from a cell to a drive device, the physical tape on which the target logical volume is to be stored in accordance with a recall instruction when the recall instruction is issued to recall the target logical volume redundantly stored on the physical tapes stored in two or more cells included in different tape library devices or in the same tape library device and to store the target logical volume in the large-scale storage device, a tape positioning time period calculator that calculates, for each of the physical tapes on which the target logical volume exists, a time period for tape positioning that is performed to read the target logical volume from the physical tape, and a physical tape selecting and determining unit that calculates, for each of the physical tapes on which the target logical volume exists, a time period from the time when the recall instruction is issued to the time when the target logical volume starts to be read from the physical tape, on the basis of the time period in which the robot moves from the cell to the drive device and the time period for the tape positioning, and that selects, from among the physical tapes as a physical tape to be subjected to a recall process to be performed in accordance with the recall instruction, a physical tape that corresponds to the shortest time period from the time when the recall instruction is issued to the time when the target logical volume starts to be read from the physical tape.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating the configuration of a system according to an embodiment.

FIG. 2 is a block diagram illustrating a virtual tape device according to the embodiment.

FIG. 3 is a diagram illustrating volume groups.

FIGS. 4A and 4B are diagrams illustrating storage into a physical volume.

FIG. 5 is a diagram illustrating recovery of a logical volume.

FIGS. 6A and 6B are diagrams illustrating a reorganization of physical volumes.

FIG. 7A is a diagram illustrating a single saving function and a single-library device.

FIG. 7B is a diagram illustrating a dual saving function and a multi-library device.

FIG. 8 is a diagram illustrating an example of the single saving function and the dual saving function.

FIG. 9 is a diagram illustrating the dual saving function of the virtual tape device.

FIG. 10 is a diagram illustrating a recall process to be performed by the virtual tape device.

FIG. 11 is a diagram illustrating an operation of calculating a time period that is required for a robot to move a tape cartridge of a tape library device to a drive.

FIG. 12 is a diagram illustrating an operation of calculating a time period that is required for a robot to move another tape cartridge of another tape library device to a drive.

FIG. 13 is a diagram illustrating an operation of calculating a time period for time positioning that is performed to read a logical volume from a physical tape of the tape cartridge of the tape library device.

FIG. 14 is a diagram illustrating an operation of calculating a time period for time positioning that is performed to read the logical volume from a physical tape of the other tape cartridge of the other tape library device.

FIG. 15 is a diagram illustrating an example of data stored in a cartridge memory.

FIG. 16 is a diagram illustrating an example of the configuration of data of an error retry number table for the tape library device.

FIG. 17 is a diagram illustrating an example of the configuration of data of an error retry number table for the other tape library device.

FIG. 18 is a diagram illustrating an example of the configuration of data of a threshold table.

FIG. 19 is a flowchart of a process to be performed by the virtual tape device according to the embodiment.

FIG. 20 is a diagram illustrating a hardware configuration of a VLP.

FIG. 21 is a diagram illustrating an example of the configuration of the tape cartridge.

FIG. 22 is a diagram illustrating an example of the configuration of the cartridge memory.

### DESCRIPTION OF EMBODIMENTS

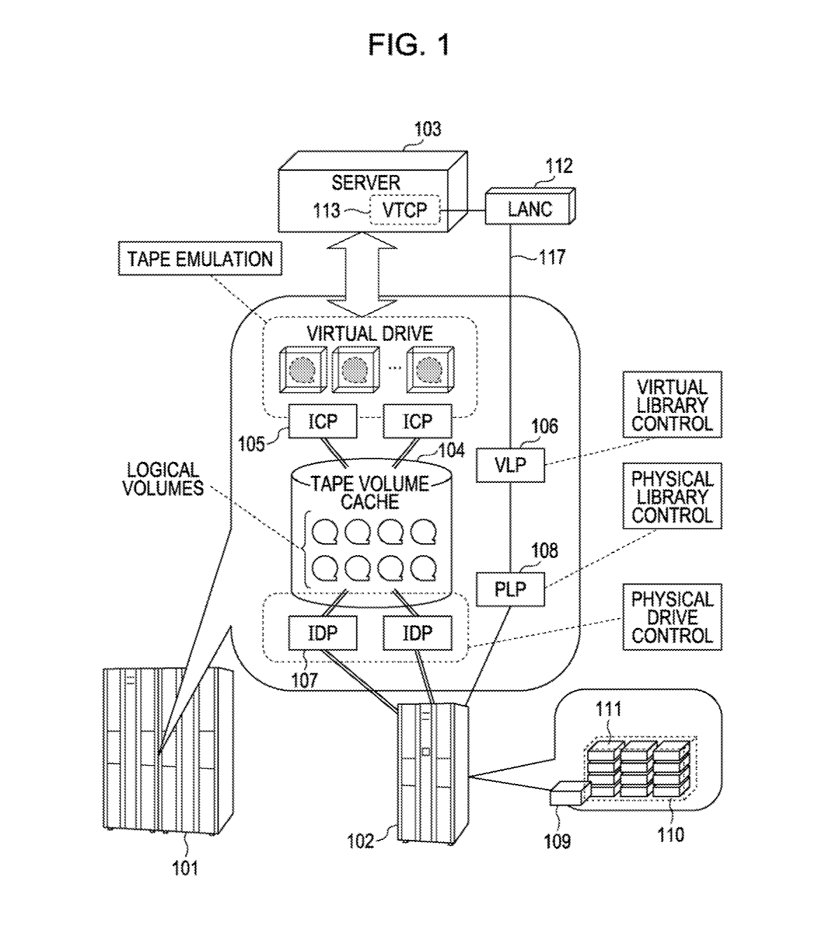

An embodiment of the art is described below in detail with reference to the accompanying drawings. FIG. 1 is a diagram illustrating the configuration of a system that includes a virtual tape device according to the present embodiment and devices located around the virtual tape device.

A virtual tape device 101 includes, as constituent elements, a tape volume cache (TVC) 104, an integrated channel processor (ICP) 105, a virtual library processor (VLP) 106, an integrated device processor (IDP) 107 and a physical library processor (PLP) 108. The TVC 104 is constituted by a redundant array of inexpensive disks (RAID) device. The TVC 104 may be constituted by a large-scale storage device such as an SSD. The ICP 105, the VLP 106, the IDP 107 and the PLP 108 are each constituted by a server computer module.

The ICP 105 is connected to a server 103 through an interface for connection. The server 103 is a host device. The ICP 105 controls transmission and reception of data of a logical volume stored in the TVC 104. A function of a virtual tape drive is executed by the server 103. The interface is a high-speed link that is provided for transfer of storage data and uses an optical fiber with the maximum transfer rate of 17 megabytes/seconds, for example.

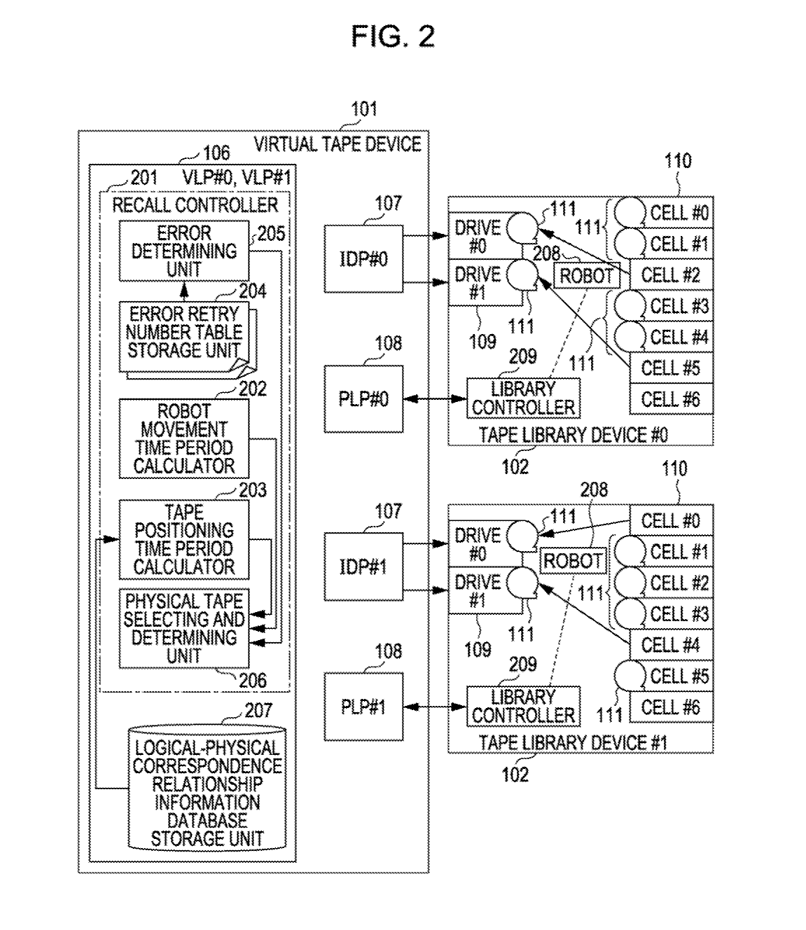

The VLP 106 receives a mount request from the server 103 and performs a process of mounting a logical volume in the virtual tape drive. In addition, the VLP 106 performs a process of managing a database (logical-physical correspondence relationship information database illustrated in FIG. 2 and described later) that stores correspondence relationships between logical volumes stored in the TVC 104 and physical volumes in tape cartridges 111. In addition, the VLP 106 performs a process of storing data on a physical tape and another process.

The IDP 107 receives an instruction from the VLP 106. The IDP 107 causes the data of the logical volume stored in the TVC 104 to be stored in a tape cartridge 111 set in a drive 109 that is included in a tape library device 102. The drive 109 is a tape drive device. The IDP 107 mounts, in the drive 109, the tape cartridge 111 stored in a cell 110 included in the tape library device 102. Then, the IDP 107 reads the data of the logical volume from the physical volume in the tape cartridge 111 and recalls the data so that the data is stored in the TVC 104.

The PLP 108 receives an instruction from the VLP 106 and controls a robot 208 (illustrated in FIG. 2) through a library controller 209 (illustrated in FIG. 2) included in the tape library device 102. The robot 208 is a medium transport mechanism and is included in the tape library device 102.

The virtual tape device 101 may divide the TVC 104 into two parts that belong to two groups, respectively, for example. The virtual tape device 101 may individually control a tape library device 102 #1 (refer to FIG. 2) and a tape library device 102 #2 (refer to FIG. 2) using the two groups. The VLP 106 may be configured so that a VLP #1 and a VLP #2 are arranged for the two groups, respectively, for example. In addition, the ICP 105 may be configured so that ICPs 105 #0 and #2 are arranged for one of the two groups and ICPs 105 #1 and #3 are arranged for the other of the two groups, for example. When the number of ICPs 105 is increased, the number of logical volumes that may be accessed by the server 103 increases. The IDP 107 may be configured so that IDPs 107 #0 and #2 are arranged for one of the two groups and IDPs 107 #1 and #3 are arranged for the other of the two groups, for example. When the number of IDPs 107 is increased, the number of drives 109 (included in the tape library devices 102) that may be controlled increases. The PLP 108 may be configured so that a PDP 108 #1 and a PDP 108 #2 (described later) are arranged for the two groups, respectively, and correspond to library controllers included in the tape library devices 102 #1 and #2 (refer to FIG. 2), for example.

The TVC 104, the ICPs 105, the VLPs 106 and the IDPs 107 are connected to each other through dedicated interfaces. One of the IDPs 107 and the drives 109 included in one of the tape library devices 102 are connected to each other through dedicated interfaces, while the other of the IDPs 107 and the drives 109 included in the other of the tape library devices 102 are connected to each other through dedicated interfaces. One of the PLPs 108 and the library controller included in one of the tape library devices 102 are connected to each other through dedicated interfaces, while the other of the PLPs 108 and the library controller included in the other of the tape library devices 102 are connected to each other through dedicated interfaces. The interfaces are high-speed links that are provided for transfer of storage data and each use an optical fiber with the maximum transfer rate of, for example, 200 megabytes/seconds or an coaxial cable with the maximum transfer rate of, for example, 200 megabytes/seconds. When the interfaces are used, a switch device (not illustrated) controls interconnections of the aforementioned parts included in each of the two groups and interconnections (of the aforementioned parts) between the two groups.

The TVC 104, the ICPs 105, the VLPs 106, the IDPs 107 and the PLPs 108 are connected to each other through a local area network (LAN) cable 117 and a plurality of hub devices and communicate with each other using control signals.

A virtual tape control program (VTCP) 113 requests, through a LAN controller (LANC) 112, the VLP 106 included in the virtual tape device 101 to mount a logical volume.

At least one drive 109 that is a physical tape drive device is arranged in each of the tape library devices 102. One IDP 107 that is included in the virtual tape device 101 may drive two drives 109, for example. In each of the tape library devices 102, the robot 208 (illustrated in FIG. 2) transports a necessary tape cartridge 111 from a cell 110 (storing tape cartridges 111) to a drive 109 and mounts the tape cartridge 111 in the drive 109. The tape cartridge 111 that is mounted in the drive 109 is accessed by the IDP 107 included in the virtual tape device 101.

FIG. 2 is a block diagram illustrating the virtual tape device 101 according to the present embodiment. In FIG. 2, the tape library devices 102 that are controlled by the virtual tape device 101 are also illustrated. In FIG. 2, parts that are the same as parts illustrated in FIG. 1 are indicated by the same reference numerals.

FIG. 2 also illustrates the configuration of a recall controller 201 that is set in the VLP 106 included in the virtual tape device 101. The recall controller 201 has the configuration to control the tape library devices 102 (#0 or #1) and performs a recall process on a logical volume stored in a duplicated manner.

In FIG. 2, the robot 208 and a plurality of cells 110 are arranged in each of the tape library devices 102 #0 and #1. The robots 208 are the medium transport mechanisms, while the cells 110 are storages in and from which the tape cartridges 111 are transported and carried out. In FIG. 2, cells 110 #0 to #6 are arranged in each of the tape library devices 102. The robots 208 that are arranged in the tape library devices 102 #0 and #1 are controlled by the PLPs 108 #0 and #1 (included in the virtual tape device 101), respectively. FIG. 2 illustrates only a pair of drives 109 #0 and #1 that are included in the tape library device 102 #0 and controlled by the IDP 107 #0 and a pair of drives 109 #0 and #1 that are included in the tape library device 102 #1 and controlled by the IDP 107 #1 in order to simplify the description. The library controllers 209 that are included in the tape library devices 102 control operations of the robots 208.

The recall controller 201 that is included in the VLP 106 (refer to FIG. 1) included in the virtual tape device 101 includes a robot movement time period calculator 202, a tape positioning time period calculator 203 and a physical tape selecting and determining unit 206. In addition, the recall controller 201 includes an error retry number table storage unit 204 and an error determining unit 205. Furthermore, the VLP 106 includes a logical-physical correspondence relationship information database storage unit 207.

When a recall instruction is issued in the VLP 106, the robot movement time period calculator 202 of the recall controller 201 calculates a time period (also called a robot movement time period) for a movement of the robot 208 included in each of the tape library devices 102 in which physical tapes on which a target logical volume to be recalled exists are included.

The robot movement time period is a time period that is required for the robot 208 to move the target tape cartridge 111 having the physical tape (on which the logical volume to be recalled exists) from the cell 110 (storing the tape cartridge 111) to the drive 109.

Specifically, the robot movement time period is a time period calculated by summing the following first and second movement time periods. The first movement time period is a time period in which the robot 208 moves from the position of the robot 208 when the recall instruction is issued to the position of the cell 110 in which the target tape cartridge 111 is stored. The second movement time period is a time period in which the robot 208 moves from the position of the cell 110 to the position of the drive 109.

In order to calculate the first and second movement time periods, the robot movement time period calculator 202 acquires the following four information pieces from the library controllers 209 included in the tape library devices 102 through the PLPs 108 #0 and #1 when the recall instruction is issued. Specifically, the robot movement time period calculator 202 acquires, as three-dimensional coordinate values from each of the library controllers 209, the current position of the robot 208, the position of the cell 110 in which the target tape cartridge 111 is stored, and the position of the drive 109 in which the target tape cartridge 111 is to be mounted. In addition, the robot movement time period calculator 202 acquires, from each of the library controllers 209, movement speeds (time periods for movements) of the robot 208 in axial directions of three-dimensional coordinates. The robot movement time period calculator 202 calculates, on the basis of the four information pieces, the time periods (robot movement time periods) required for the robots 208 (included in the tape library devices 102 having physical tapes on which the logical volume to be recalled exists) to move the tape cartridges 111 to the drives 109.

When the recall instruction is issued in the VLP 106, the tape positioning time period calculator 203 of the recall controller 201 calculates a tape positioning time period for each of the physical tapes on which the logical volume to be recalled exists.

The tape positioning time period is a time period that is required for a head (included in the drive 109 in which the target tape cartridge 111 is mounted in the tape library device 102) to move to a location at which a data block of the logical volume to be recalled is stored.

In order to calculate the tape positioning time period, the tape positioning time period calculator 203 references a logical-physical correspondence relationship information database that is held by the logical-physical correspondence relationship information database storage unit 207 included in the VLP 106. Thus, the tape positioning time period calculator 203 acquires information of the positions (sector position) of the logical volume (to be recalled) on the physical tape on which the logical volume to be recalled exists. The tape positioning time period calculator 203 calculates the tape positioning time period on the basis of the information of the position of the logical volume and the speed of the tape in the drive 109.

The physical tape selecting and determining unit 206 of the recall controller 201 calculates a value obtained by summing the robot movement time period calculated by the robot movement time period calculator 202 and the tape positioning time period calculated by the tape positioning time period calculator 203 for each of the physical tapes on which the logical volume to be recalled exists. The summed values each indicate a time period (hereinafter also called “time period required to start reading”) from the time when the recall instruction is issued to the time when the logical volume starts to be read from the interested physical tape. The physical tape selecting and determining unit 206 selects, as a physical tape to be subjected to the recall process from among the physical tapes (tape cartridges 111) included in the tape library devices 102, a physical tape corresponding to the shortest “time period required to start reading” among the “time periods that are required to start reading” and have been calculated for the physical tapes.

After that, the recall controller 201 starts performing the recall process on the selected physical tape. In the present embodiment, the recall controller 201 may select, from among two physical tapes on which the logical volume to be recalled exists, a physical tape from which the data may be read most quickly.

In addition to the aforementioned operation, the physical tape selecting and determining unit 206 performs the following control in the process of selecting and determining a physical tape. First, the recall controller 201 stores, in an error retry number table of the storage unit 204, the numbers of error retries performed on all the physical tapes included in the tape library devices 102.

Then, the error determining unit 205 that is included in the recall controller 201 references the error retry number table and acquires the numbers of various types of error retries performed on each of the physical tapes from the logical volume to be recalled exists when the recall instruction is issued. The error determining unit 205 determines, on the basis of the acquired numbers of the various types of error retries, whether or not the physical tapes on which the logical volume to be recalled exists may be selected.

The physical tape selecting and determining unit 206 selects a physical tape from among the physical tapes on which the logical volume to be recalled exists on the basis of the results of the determinations made by the error determining unit 205. In this manner, the recall controller 201 may perform a control operation to avoid performing the recall process on a physical tape in which an error easily occur and that is among the two physical tapes on which the logical volume to be recalled exists.

Since the recall controller 201 performs the aforementioned two control operations, the recall controller 201 may start to optimally perform the recall process.

Detailed operations of the thus-configured virtual tape device 101 according to the present embodiment are described below.

In the system configuration illustrated in FIG. 1, in response to a mount request provided from the VTCP 103 executed on the sever 103, the virtual tape device 101 prepares a data storage region for an interested tape volume stored in the TVC 104 that is the RAID disk, for example. The virtual tape device 101 behaves like a normal track tape device on the server 103 through an interface of a drive path and receives and transmits data. The data is read from and written in the TVC 104.

Volume data that is stored in the TVC 104 and emulated is a logical volume. All logical volumes are backed up and stored in the actual tape cartridges 111 included in the tape library devices 102 that are back-end tape library devices. The tape cartridges 111 that are included in the tape library devices 102 are physical volumes.

The logical volumes that are used in the TVC 104 are stored in (or migrated to) the physical volumes of the tape library devices 102 in response to an unload request provided from the server 103. However, when the logical volumes are accessed only to be read and are not changed, this process is not performed. In addition, data of the logical volumes is not deleted and is held until the TVC 104 is filled with data.

An operational example of the virtual tape device 101 when the server 103 executes a job for a logical volume LV0001 is described below. In this example, it is assumed that data of the logical volume LV0001 is already stored in a physical volume PV0002.

In step 1, the server 103 issues a request to mount the logical volume LV0001. The virtual tape device 101 receives the request using the VLP 106.

In step 2, the VLP 106 references the TVC 104 and checks whether or not the TVC 104 has a sufficient available memory space to store the logical volume.

When the TVC 104 does not have the available memory space, a logical volume is deleted on the basis of a least recently used (LRU) logic in order from a logical volume on which the last access to the logical volume is performed earliest so that the available memory space is formed. However, when the size of a logical volume on which the last access to the logical volume is performed earliest is small, the logical volume is not deleted and a logical volume that has a larger size is prioritized in some cases. The LRU logic is a scheme in which data is extracted in order from data on which the last access to the data is performed earliest and that has a large size.

In step 3, the VLP 106 checks whether or not the logical volume to be stored according to the request exists in the TVC 104.

When the logical volume exists in the TVC 104, the VLP 106 reports completion of the mounting to the server 103. Specifically, the VLP 106 notifies the ICP 105 of the completion of the mounting, and the ICP 105 issues a “Not Ready to Ready” interrupt to the server 103.

When the logical volume does not exist in the TVC 104, the VLP 106 searches the logical-physical correspondence relationship information database (refer to FIG. 2) that is held by the logical-physical correspondence relationship information database storage unit 207. As a result, the VLP 106 detects that a physical volume in which the logical volume LV0001 to be stored according to the request is stored is the physical volume PV0002. Then, the VLP 106 instructs the interested tape library device 102 to mount the physical volume PV0002 and instructs the IDP 107 to read the target logical volume LV0001 into the TVC 104 from the physical volume PV0002. When the reading of the logical volume is completed, the VLP 106 reports the completion of the mounting to the server 103. During a time period to the time when the completion of the mounting is reported, the server 103 is in a mount pending state.

In step 4, the server 103 reads or writes data of the logical volume LV0001.

In step 5, the VLP 106 checks whether or not the data of the logical volume LV0001 is changed.

When the data of the logical volume LV0001 is not changed, a post-process is not performed. When the data of the logical volume LV0001 is changed, the VLP 106 searches an appropriate physical volume in which the changed (updated) data of the logical volume is to be stored. When the physical volume PV0002 has a sufficient available space, the new data of the logical volume LV0001 is stored in the physical volume PV0002 or stored in a region located at the back of a lastly written logical volume. When the physical volume PV0002 does not have the sufficient available space, the new data of the logical volume LV0001 is stored in another physical volume. In this case, the data (of the logical volume LV0001 before the updating) that is previously written in the physical volume PV0002 becomes invalid in the logical-physical correspondence relationship information database, and the newly written data of the logical volume LV0001 is valid.

In step 6, when the server 103 reissues, to the physical volume PV0002, the request to mount the logical volume LV0001 stored in the physical volume PV0002, the completion of the mounting may be immediately returned. The logical volume remains in the TVC 104 until the data of the logical volume is deleted from the TVC 104 according to the LRU logic in order to form an available memory space for storing other data. Even when the data of the logical volume is deleted from the TVC 104, the data of the logical volume exists in the physical volume included in the tape library device 102.

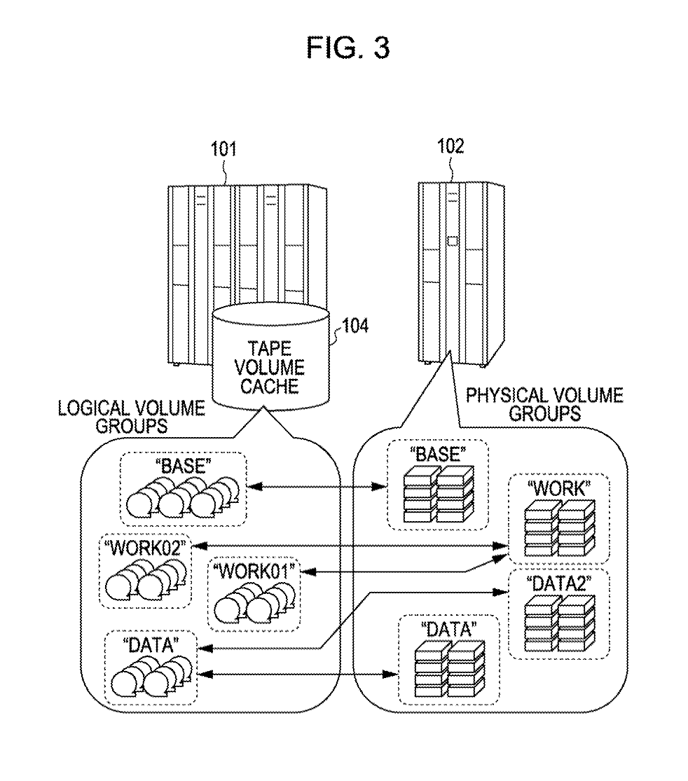

Next, volumes and volume groups are described with reference to FIG. 3. As illustrated in FIG. 3, the logical volumes that are stored in the TVC 104 are divided into logical volume groups. All the logical volumes each belong to any of the groups. In an initial state, a “BASE” logical volume group is prepared, and an arbitrary logical volume group may be formed.

In addition, as illustrated in FIG. 3, the physical volumes that are stored in the tape library device 102 are each registered in any of volume groups that are called physical volume groups.

As illustrated in FIG. 3, when the logical volume groups are assigned to the physical volume groups, data that is written in a certain logical volume from the server 103 is stored in a physical volume that is among physical volumes belonging to a physical volume group linked to a volume group to which the certain logical volume belongs.

Physical volumes in which data is stored may be expressly divided into volume groups by grouping the volumes for each of servers 103 or for each of jobs. In addition, the dual saving function (described later) is performed by linking one logical volume group to two physical volume groups.

A logical volume is stored in (or migrated to) a physical volume in accordance with an unload command provided from the server 103 to the virtual drive. When the logical volume is not changed, the logical volume is not newly stored in a physical volume.

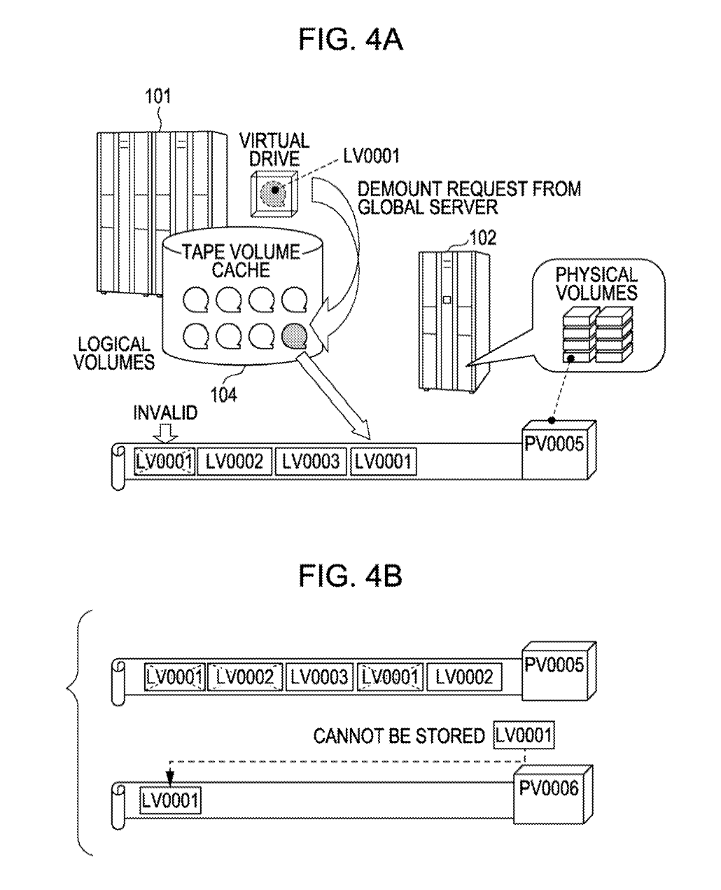

FIGS. 4A and 4B are diagrams illustrating storage into a physical volume. In a first example (illustrated in FIG. 4A) of storage into the physical volume, after the logical volume LV0001 is updated, a process of storing the logical volume LV0001 in the physical volume is performed in accordance with an unload command. In the first example, the logical volume LV0001 is stored in a region located at the back of a logical volume lastly written in a physical volume PV0005. The data (of the logical volume LV0001) that is previously stored in the physical volume 5 becomes invalid in the logical-physical correspondence relationship information database (refer to FIG. 2).

In a second example (illustrated in FIG. 4B) of storage into a physical volume, when updating of logical volumes is repeated, and data of a logical volume reaches an end of the physical volume PV0005 and may not be stored in the physical volume PV0005, the logical volume is stored in another physical volume PV0006 that belongs to the same physical volume group as the physical volume PV0005.

When a small-capacity track tape cartridge is emulated, the logical volumes each have a capacity of approximately 800 megabytes, for example. On the other hand, when a large-capacity tape cartridge is used, the physical volumes each have a capacity of 800 gigabytes, for example. Thus, many logical volumes may be stored in each of the physical volumes.

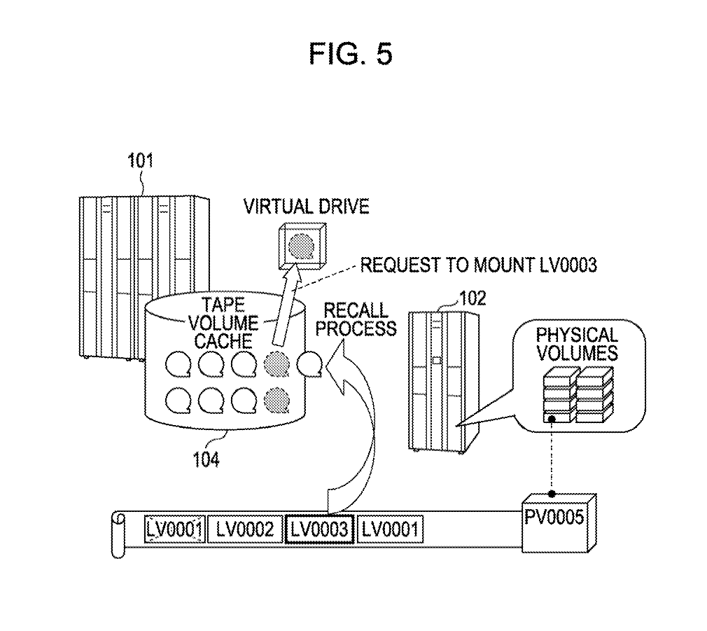

When a request to mount a logical volume that does not exist in the TVC 104 is issued, or when a request to preload a logical volume that does not exist in the TVC 104 is issued, the aforementioned recall process is performed. FIG. 5 is a diagram illustrating restoration of a logical volume in the recall process. In an example (illustrated in FIG. 5) of the restoration of a logical volume, the VLP 106 of the virtual tape device 101 instructs the PLP 108 and the IDP 107 so that the physical volume of the tape library device 102 is mounted in the drive 109. The VLP 106 reads a target logical volume into the TVC 104. The completion of the mounting is reported to the server 103 after the reading of the logical volume is completed. During a time period to the time when the completion of the mounting is reported, the server 103 is in the mount pending state.

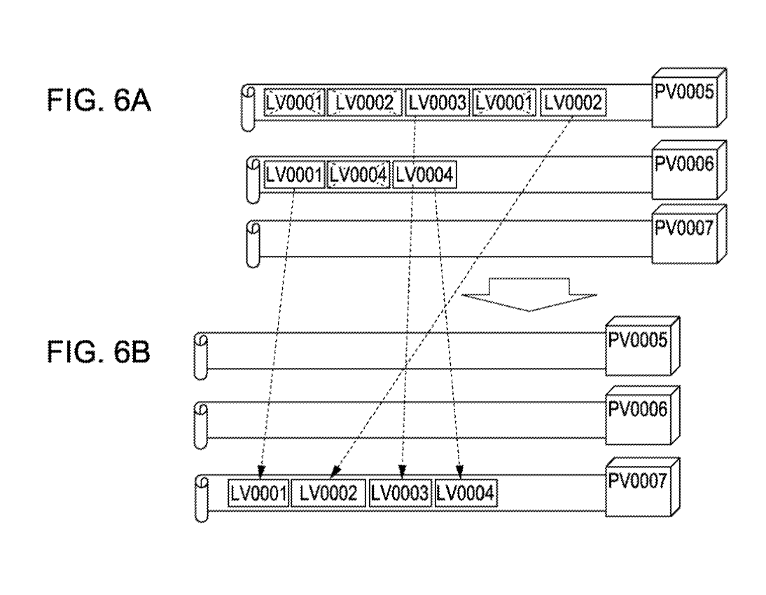

FIGS. 6A and 6B are diagrams illustrating a reorganization of physical volumes. As described with reference to FIGS. 4A and 4B, when a logical volume is updated, data that is previously written in a physical volume before the updating becomes invalid, and new data is written in a region located at the back of a logical volume lastly written in the physical volume. When the process described in the first example (illustrated as FIG. 4A) of storage in a physical volume is repeated, the number of invalid regions in the physical volume increases, and the number of available physical volumes of an interested physical volume group is reduced, as illustrated in FIG. 6A. In order to improve this, the virtual tape device 101 may have a reorganization function. The reorganization function collects only data of valid logical volumes from a physical volume into another physical volume, and initializes the original physical tape. In an example illustrated in FIGS. 6A and 6B, logical volumes that are stored in the physical volumes PV0005 and PV0006 are collected into a physical volume PV0007, and the physical volumes PV0005 and PV0006 become available. This reorganization process is automatically performed by the virtual tape device 101 for each of the physical volume groups. Settings of the physical volume groups include an item related to the reorganization. As requirements to perform the reorganization process, a remaining number of turns of each of available physical volumes, and a time zone in which the reorganization process is performed, may be specified.

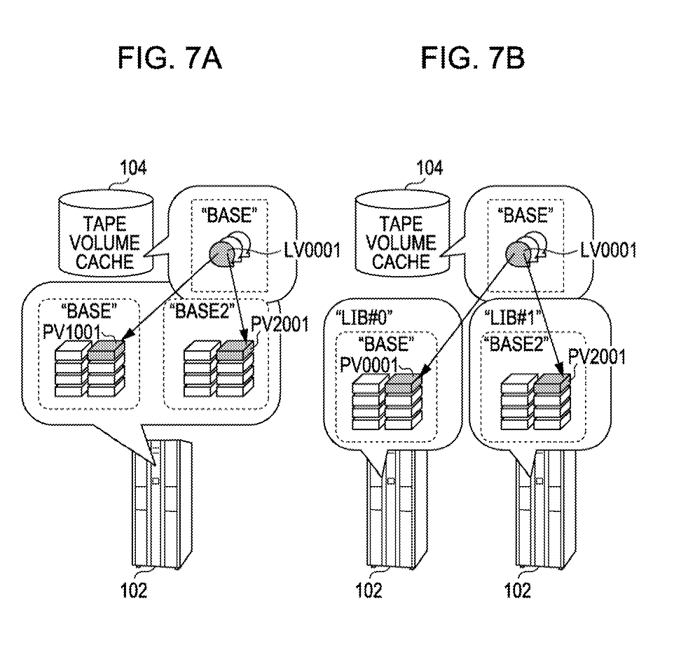

FIG. 7A is a diagram illustrating a single saving function and a single-library device, while FIG. 7B is a diagram illustrating the dual saving function and a multi-library device. The physical volumes (tape cartridges 111) that are arranged in the tape library devices 102 may be duplicated by the dual saving function. Normally, data of a logical volume is stored only in a single physical volume. However, data of a logical volume that is set to be duplicated by the dual saving function and is duplicated by the dual saving function is stored in two physical volumes. Thus, when the data of the logical volume may not be read from one of the two physical volumes owing to a media error or the like, the data of the logical volume may be restored from the other of the two physical volumes.

The dual saving function operates by applying a target logical volume group to two physical volume groups. In an example (illustrated in FIG. 7A) of a single-library configuration, the logical volume LV0001 is stored in physical volumes PV1001 and PV2001 by assigning the logical volume group “BASE” to physical volume groups “BASE” and “BASE2”.

When a multi-library option is used, the two tape library devices 102 may be simultaneously connected to the virtual tape device 101 as illustrated in the configuration example of FIG. 2. When the multi-library option and the dual saving function are used, a logical volume may be duplicated by setting the multi-library option and the dual saving function so that the logical volume is stored in physical volumes that are located in the two tape library devices 102, respectively. In this case, the system has redundancy to handle not only a media error of a physical volume but also failures of the tape library devices 102. In an example (illustrated in FIG. 7B) of a multi-library configuration, the logical volume group “BASE” is assigned to the physical volumes “BASE” and “BASE2” that are included in the tape library devices 102 #0 (LIB#0) and #1 (LIB#1), respectively. Thus, the logical volume LV0001 is stored in the physical volumes PV1001 and PV2001.

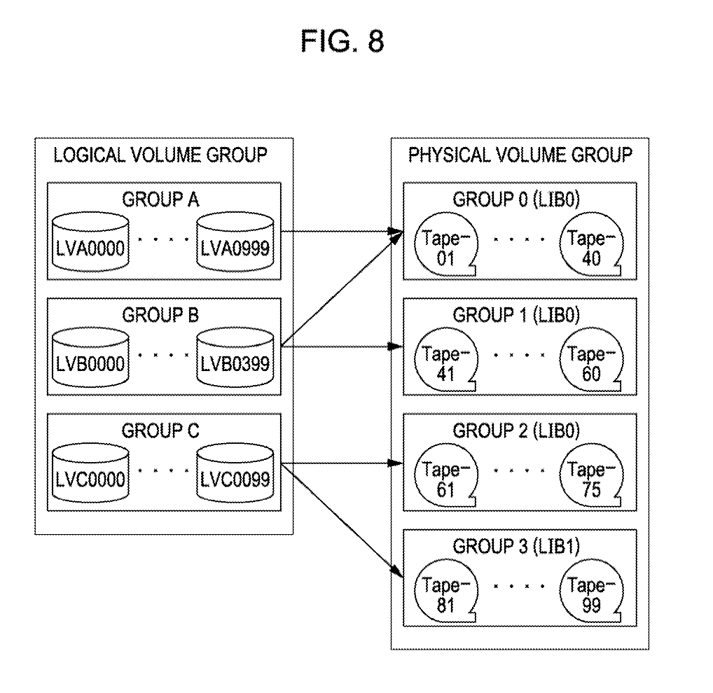

FIG. 8 is a diagram illustrating an example of the single saving function and the dual saving function. A logical volume that is registered in a logical volume group A is written in a physical volume that is included in a physical volume group 0 (single saving function).

A logical volume that is registered in a logical volume group B is written in physical volumes that exist in the physical volume group 0 and a logical volume group 1, respectively (dual saving function). A logical volume that is registered in a logical volume group C is written in physical volumes that exist in physical volume groups 2 and 3 (dual saving function).

The states of physical tapes that are included in physical tape groups are checked in order to write a logical volume, and the logical volume is written in a physical volume in the best state for writing. When the physical volume is mounted in a drive, the logical volume is written in the physical volume mounted in the drive. For example, the logical volume that is registered in the logical volume group A is updated and starts to be written in the physical volume group 0. In this case, a physical tape on which the same logical volume is previously written is selected and mounted in the drive, and the logical volume is written on the physical tape. After that, the logical volume that is registered in the logical volume group B is updated and written in physical volumes that are included in the physical volume groups 0 and 1, respectively. In this case, since the physical volume that is included in the physical volume group 0 is already mounted in the drive, the logical volume is written in the physical volume. In addition, a physical tape on which the same logical volume is previously written is selected in the physical volume group 1, and the logical volume is written on the selected physical tape.

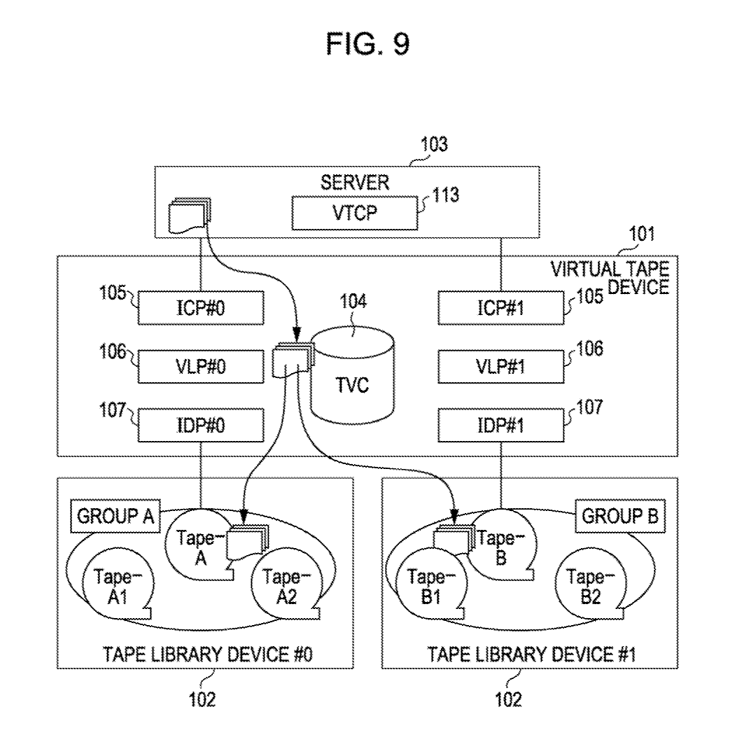

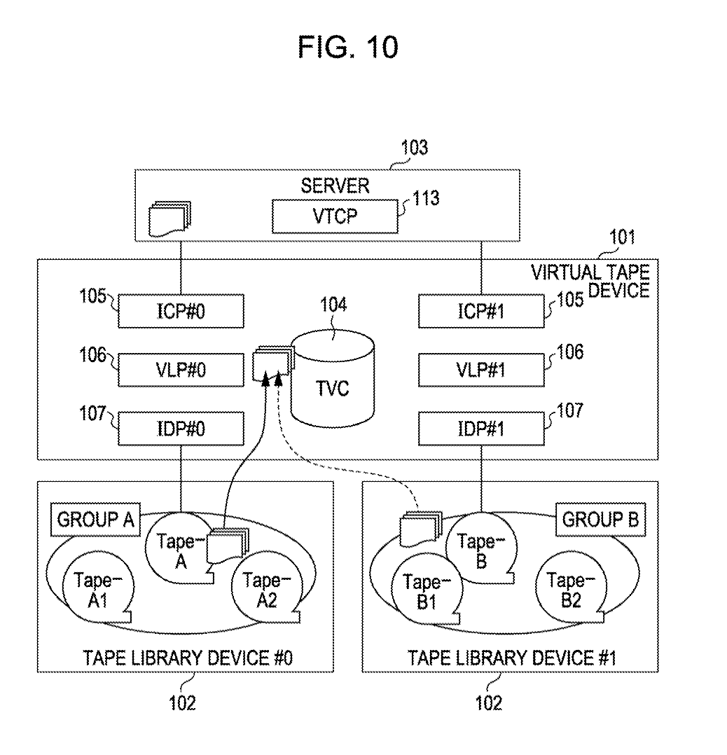

Next, the relationship between the dual saving function of storing data in the multi-library device and the recall process to be performed on the data stored by the dual saving function is described below. FIG. 9 is a diagram illustrating the dual saving function of the virtual tape device. FIG. 10 is a diagram illustrating the recall process to be performed by the virtual tape device.

When a logical volume that is stored in the TVC 104 included in the virtual tape device 101 is changed, the logical volume is stored in (migrated to) a physical volume in accordance with an unload command provided from the server 103 to the virtual drive. In this case, when the dual saving function of the multi-library device is valid, the logical volume is saved as illustrated in FIG. 9, for example. Specifically, the logical volume is stored in both tape cartridge Tape-A included in the physical volume group A included in the tape library device 102 #0 and tape cartridge Tape-B included in the physical volume group B included in the tape library device 102 #1.

When the recall process is to be performed on the data migrated in the aforementioned manner, it is important that the process is optimally performed to recall the target logical volume from either a physical volume included in the tape library device 102 #0 or a physical volume included in the tape library device 102 #1.

The process is optimally performed by the functions of the recall controller 201 illustrated in FIG. 2. Details of the functions of the recall controller 201 are described below. First, details of an operation of the robot movement time period calculator 202 (included in the recall controller 201 illustrated in FIG. 2) described above are described.

As described above, the robot movement time period calculator 202 calculates, for each of physical tapes on which the target logical volume to be recalled exists, a time period (robot movement time period) that is required for the robot 208 (included in the tape library device 102) to move the physical tape to the drive 109. The robot movement time period is indicated by Time-1; a time period in which the robot 208 moves from the current position of the robot 208 to the cell 110 in which the physical tape on which the logical volume to be recalled exists is stored is indicated by Time-1a; and a time period in which the robot 208 moves from the cell 110 to the drive 109 in which the physical tape on which the logical volume to be recalled exists is to be mounted. In this case, the time period Time-1 is calculated according to the following Equation (1).

Time-1=Time-1a+Time-1b (1)

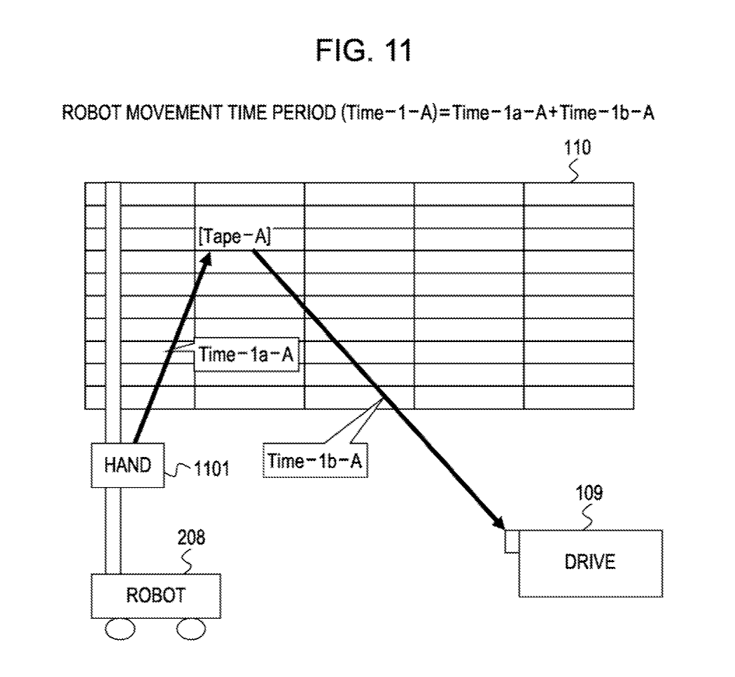

FIG. 11 is a diagram illustrating an operation of calculating the time period (robot movement time period) Time-1 that is required for the robot to move the tape cartridge Tape-A included in the tape library device 102 #0 to the drive 109. In the aforementioned example illustrated in FIG. 10, it is assumed that the robot 208, the cell 110 (indicated by [Tape-A] in FIG. 11) in which the tape cartridge Tape-A is stored, and the drive 109 in which the tape cartridge 111 (Tape-A) is to be mounted, have positional relationships illustrated in FIG. 11. In this case, it is assumed that the robot 208 moves in X direction (left-right direction in FIG. 11) and Z direction (front-back direction in FIG. 11) and that a hand 1101 of the robot 208 moves in Y direction (top-bottom direction in FIG. 11). In this manner, the robot 208 moves to the cell 110 (indicated by [Tape-A] in FIG. 11) in order to receive the tape cartridge Tape-A. The time period in which the robot 208 moves to the cell 110 is indicated by Time-1a-A as illustrated in FIG. 11. Next, the hand 1101 receives the tape cartridge Tape-A. After that, the tape cartridge Tape-A is transported to the drive 109 by the robot 208 while the robot 208 moves in X and Z directions and the hand 1101 moves in Y direction. The time period in which the robot 208 moves from the cell 110 to the drive 109 is indicated by Time-1b-A as illustrated in FIG. 11. When a time period (robot movement time period) that is required for the robot 208 to move the tape cartridge Tape-A to the drive 109 is indicated by Time-1-A, the time period Time-1-A is calculated according to the aforementioned Equation (1) and expressed by the following equation.

Time-1-A=Time-1a-A+Time-1b-A

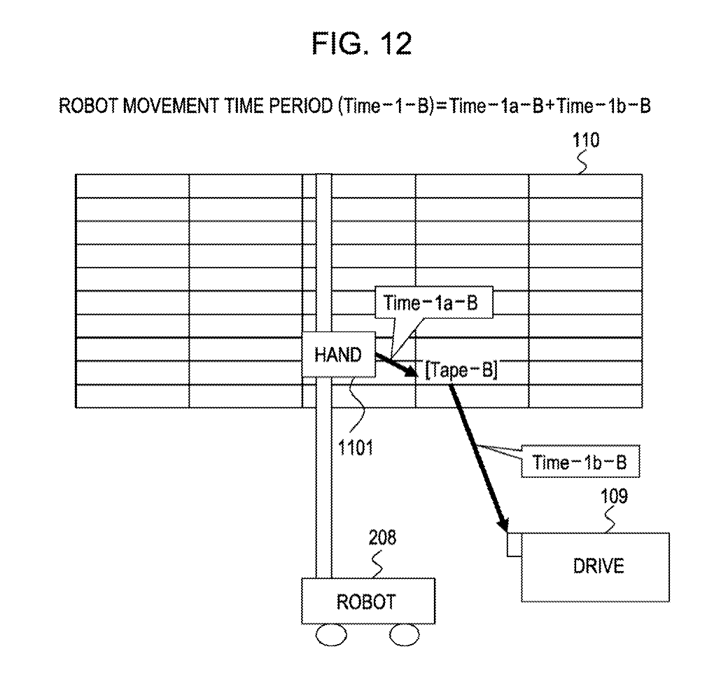

FIG. 12 is a diagram illustrating an operation of calculating a time period (robot movement time period) Time-1 that is required for the robot 208 to move the tape cartridge Tape-B included in the tape library device 102 #1 to the drive 109. In the aforementioned example illustrated in FIG. 10, it is assumed that the robot 208, the cell 110 (indicated by [Tape-B] in FIG. 12) in which the tape cartridge Tape-B is stored, and the drive 109 in which the tape cartridge 111 (Tape-B) is to be mounted, have positional relationships illustrated in FIG. 12, for example. In this case, the robot 208 moves to the cell 110 (indicated by [Tape-B] in FIG. 12) in order to receive the tape cartridge Tape-B while the robot 208 and hand 1101 move. The time period in which the robot 208 moves to the cell 110 (indicated by [Tape-B] in FIG. 12) is indicated by Time-1a-B as illustrated in FIG. 12. Next, the hand 1101 receives the tape cartridge Tape-B. After that, the tape cartridge Tape-B is transported to the drive 109 by the robot 208 while the robot 208 and hand 1101 move. The time period in which the robot 208 moves from the cell 110 to the drive 109 is indicated by Time-1b-B as illustrated in FIG. 11. When a time period (robot movement time period) that is required for the robot 208 to move the tape cartridge Tape-B to the drive 109 is indicated by Time-1-B, the time period Time-1-B is calculated according to the aforementioned Equation (1) and expressed by the following equation.

Time-1-B=Time-1a-B+Time-1b-B

Specifically, a detailed example of the calculations of the robot movement time periods by the robot movement time period calculator 202 is described below.

The time period in which the robot moves a distance corresponding to one cell in X direction: 500 ms (milliseconds)

The time period in which the hand moves a distance corresponding to one cell in Y direction: 500 ms

The time period in which the robot moves in Z direction: 300 ms

The robot movement time period=The number of cells corresponding to a distance that the robot moves in X direction×The time period in which the robot moves a distance corresponding to one cell+The number of cells corresponding to a distance that the hand moves in Y direction×The time period in which the hand moves a distance corresponding to one cell+The time period in which the robot moves in Z direction (when the robot moves in Z direction)

<For Tape Cartridge Tape-A in Example Illustrated in FIG. 11>

The position of the robot 208: X=0, Y=0, Z=0

The position of the cell 110 in which the tape cartridge Tape-A is stored: X=1, Y=8, Z=0

The position of the drive 109: X=5, Y=0, Z=0

The time period (robot movement time period) that is required for the robot 208 to move the tape cartridge Tape-A to the drive 109=(1−0)×500 ms+(8−0)×500 ms+(0−0)×300 ms+(5−1)×500 ms+(8−0)×500 ms+(0−0)×300 ms=10500 ms (2)

<For Tape Cartridge Tape-B in Example Illustrated in FIG. 12>

The position of the robot 208: X=3, Y=3, Z=0

The position of the cell 110 in which the tape cartridge Tape-B is stored: X=4, Y=2, Z=0

The position of the drive 109: X=5, Y=0, Z=0

Time period (robot movement time period) that is required for the robot 208 to move the tape cartridge Tape-B to the drive 109=(4−3)×500 ms+(3−2)×500 ms+(0−0)×300 ms+(5−4)×500 ms+(2−0)×500 ms+(1−0)×300 ms=2800 ms (3)

In order to perform each of the aforementioned calculations, the robot movement time period calculator 202 (illustrated in FIG. 2) accesses the interested library controller 209 (included in the tape library device 102) from the PLP 108 and acquires the current position of the interested robot 208, the position of the interested cell and the position of the interested drive 109. In addition, the robot movement time period calculator 202 acquires the movement speed (time period for a movement) of the interested robot 208 in each of the axial directions of the three-dimensional coordinates. Then, the robot movement time period calculator 202 calculates the robot movement time period on the basis of the aforementioned information as described in the example of the calculations.

Next, details of an operation of the tape positioning time period calculator 203 (included in the recall controller illustrated in FIG. 2) are described below. The tape positioning time period calculator 203 calculates a time period (tape positioning time period) in which the head moves to a data block to be recalled in each of the drives 109 in which tape cartridges 111 for physical tapes to on which the data block to be recalled exists are mounted.

The tape positioning time period (indicated by Time-2) is a time period in which the head moves until the head starts to read the data from the physical tape on which the data to be recalled exists. The dual saving function writes the same data in two physical tapes. However, the same data is not necessarily written in two physical tapes by the dual saving function. The plurality of physical tapes that are included in each of the tape library devices 102 each belong to any of the physical tape groups as described above. In order to write data in any of the physical tapes, the states of the physical tapes included in the physical tape groups are checked. Then, a physical tape that is in the best state for writing the data is selected from among the physical tapes. Then, the data is written in the selected physical tape. Thus, the positions of target data blocks (to be read) on physical tapes vary from physical tape to physical tape.

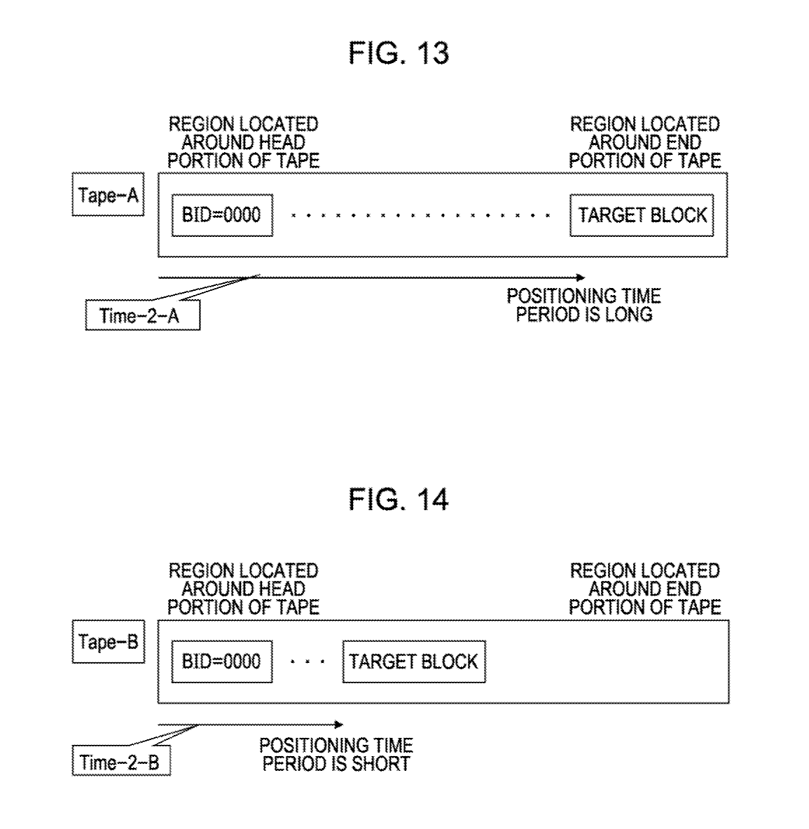

FIG. 13 is a diagram illustrating an operation of calculating a time period (Tape-2) in which the head moves until the head starts to read data from a physical tape of the tape cartridge Tape-A included in the tape library device 102 #0. In the example illustrated in FIG. 10, when a target data block (to be recalled) on the physical tape of the tape cartridge Tape-A is located around an end portion of the physical tape, a time period (Time-2-A) in which the head moves until the head starts to read the data block from the physical tape of the tape cartridge Tape-A is significantly long as illustrated in FIG. 13, for example.

FIG. 14 is a diagram illustrating an operation of calculating a time period (Tape-2) in which the head moves until the head starts to read data from a physical tape of the tape cartridge Tape-B included in the tape library device 102 #0. In the example illustrated in FIG. 10, when a target data block (to be recalled) on the physical tape of the tape cartridge Tape-B is located in a first half region of the physical tape, a time period (Time-2-B) in which the head moves until the head starts to read the data block from the physical tape of the tape cartridge Tape-B is short as illustrated in FIG. 14, for example.

Specifically, an example of a calculation of the tape positioning time period (Time-2) by the tape positioning time period calculator 203 is described below.

The time period for a movement corresponding to one sector: 1.3 seconds

<For Tape Cartridge Tape-A in Example Illustrated in FIG. 13>

The position of the target data block: 63 sectors×1300 ms

The time period in which the head moves until the head starts to read data from the physical tape of the tape cartridge Tape-A: 81900 ms (4)

<For Tape Cartridge Tape-B in Example Illustrated in FIG. 14>

The position of the target data block: 15 sectors×1300 ms

The time period in which the head moves until the head starts to read the data from the physical tape of the tape cartridge Tape-B: 19500 ms (5)

In order to perform each of the aforementioned calculations, the tape positioning time period calculator 203 (illustrated in FIG. 2) references the logical-physical correspondence relationship information database held by the VLP 106 (illustrated in FIG. 2) in the logical-physical correspondence relationship information database storage unit 207 as described above. Then, the tape positioning time period calculator 203 acquires information of the position of a sector that is located on the physical tape (on which data to be recalled exists) of the tape cartridge 111 and in which a head block of the data to be recalled is stored. Then, the tape positioning time period calculator 203 calculates the tape positioning time period Time-2 on the basis of the information of the position of the sector and a time period (tape speed) in which the tape moves a distance corresponding to one sector in the drive 109.

The physical tape selecting and determining unit 206 that is included in the recall controller 201 illustrated in FIG. 2 sums the robot movement time period calculated in the aforementioned manner and the tape positioning time period calculated in the aforementioned manner for each of the physical tapes on which the data to be recalled exists. Specifically, the following calculation is performed.

The “time period required to start reading” the data from the physical tape of the tape cartridge Tape-A=Time-1-A (robot movement time period)+Time-2-A (tape positioning time period)

The “time period required to start reading” the data from the physical tape of the tape cartridge Tape-B=Time-1-B (robot movement time period)+Time-2-B (tape positioning time period)

For example, the time period (robot movement time period) (=10500 ms (Equation 2)) required for the robot 208 to move the tape cartridge Tape-A to the drive 109, and the time period (tape positioning time period) (=81900 ms (Equation 4)) in which the head moves until the head starts to read the data from the physical tape of the tape cartridge Tape-A, are summed so that the “time period required to start reading” the data from the physical tape of the tape cartridge Tape-A is obtained, which is 92400 ms. In the same manner, the time period (robot movement time period) (=2800 ms (Equation 3)) required for the robot 208 to move the tape cartridge Tape-B to the drive 109, and the time period (tape positioning time period) (=19500 ms (Equation 5)) in which the head moves until the head starts to read the data from the physical tape of the tape cartridge Tape-B, are summed so that the “time period required to start reading” the data from the physical tape of tape cartridge Tape-B is obtained, which is 22300 ms.

Then, the physical tape selecting and determining unit 206 selects a physical tape on the basis of the following determination logic.

<Determination Method>

The physical tape selecting and determining unit 206 compares “time periods required to start reading” the data from physical tapes (to be compared) are compared. Then, the physical tape selecting and determining unit 206 selects, from among the physical tapes to be compared, a physical tape that corresponds to the shortest “time period required to start reading”.

When the “time period required to start reading” the data from the physical tape of the tape cartridge Tape-A is equal to or shorter than the “time period required to start reading” the data from the physical tape of the tape cartridge Tape-B, the physical tape selecting and determining unit 206 selects the physical tape of the tape cartridge Tape-A.

When the “time period required to start reading” the data from the physical tape of the tape cartridge Tape-A is longer than the “time period required to start reading” the data from the physical tape of the tape cartridge Tape-B, the physical tape selecting and determining unit 206 selects the physical tape of the tape cartridge Tape-B.

As a result, the physical tape selecting and determining unit 206 may select, as a physical tape to be subjected to the recall process, the physical tape (of the tape cartridge Tape-B included in the tape library device 102 #1) that corresponds to the shorter “time period required to start reading”.

In addition to the aforementioned operation, the physical tape selecting and determining unit 206 (illustrated in FIG. 2) selects and determines a physical tape on the basis of an error occurrence in the physical tapes in the process of selecting and determining a physical tape. Details of this process are described below.

In the present embodiment, an electrically erasable programmable ROM (EEPROM) that is called a cartridge memory (CM) is embedded in each of the tape cartridges 111 to be mounted in the drives 109. The capacities of the cartridge memories are approximately in a range of 4 kilobytes to 8 kilobytes. Various types of management information may be stored in each of the cartridge memories. After the management information is loaded into the drives 109 using a radio frequency (RF) interface without a physical contact, indexes of the tape cartridges 111, the usage statuses of the tape cartridges 111, and the like may be checked for a short time.

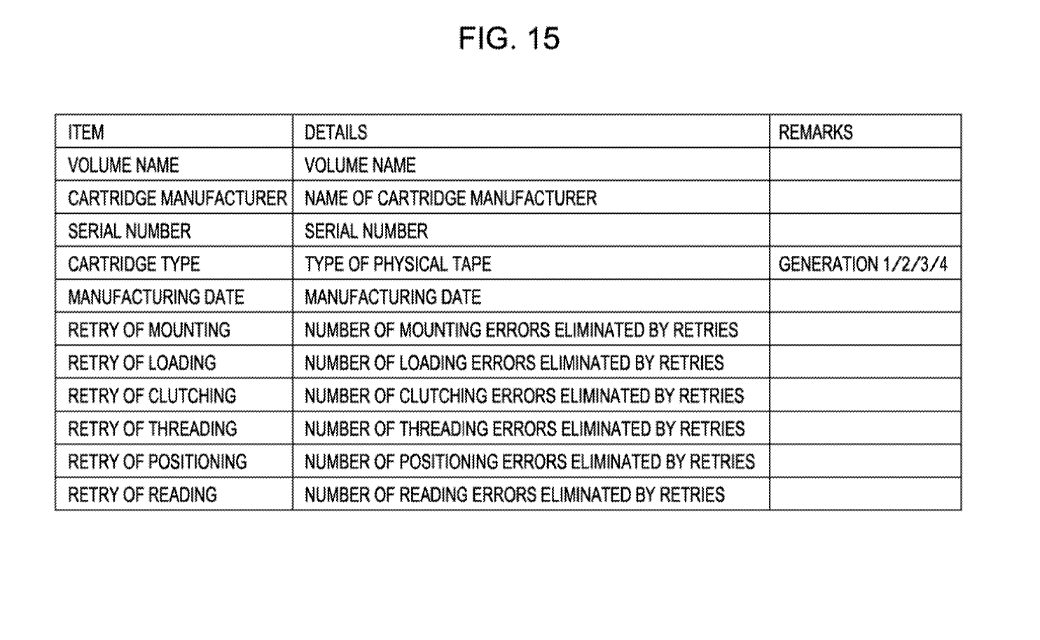

FIG. 15 is a diagram illustrating an example of data stored in the cartridge memories. Identification information such as a volume name, a cartridge manufacturer, a serial number, the type of a physical tape and a manufacturing date is stored in each of the cartridge memories. In addition, information (error information) that indicates the state of an error that occurs during an operation of an interested physical tape is stored in each of the cartridge memories.

The error information includes an item for retries of mounting. The item for retries of mounting is information that is a value that is incremented by one when an error of retracting an interested physical tape into a drive 109 occurs and is eliminated by a retry (error retry) of retracting the physical tape into the drive 109. The error information also includes an item for retries of loading. The item for retries of loading is information that is a value that is incremented by one when an error of loading the physical tape to a location at which the physical tape may be wound occurs and is eliminated by a retry (error retry) of loading the physical tape to the location at which the physical tape may be wound. In the state in which the loading is completed, a disk-shaped clutch disk that is located on the side of a back surface of the physical tape may be turned. The clutch disk is connected to a central shaft around which the physical tape is wound. The physical tape may be wound by turning the clutch disk.

The error information includes an item for retries of clutching. The item for retries of clutching is information that is a value that is incremented by one when an error of establishing the connection to the clutch disk occurs and is eliminated by a retry (error retry) of establishing the connection to the clutch disk. The clutch disk has a gear-like groove. The gear-like groove of the clutch disk is connected to a gear located on the side of the physical drive.

The error information includes an item for retries of threading. The item for retries of threading is information that is a value that is incremented by one when an error of extracting the physical tape from the tape cartridge 111 occurs and is eliminated by a retry (error retry) of extracting the physical tape from the tape cartridge 111. A leader pin is attached to an edge portion of the physical tape. The pin is held in order to extract the physical tape. Then, the pin passes through a drive head. The tape is then extracted and reaches a tape winding mechanism from which the tape may not be detached. Thus, the head may read data from the physical tape and write data in the physical tape.

The error information includes an item for retries of positioning. The item for retries of positioning is information that is a value that is incremented by one when an error of positioning the head in front of a target block (data) occurs and is eliminated by a retry (error retry) of the positioning the head in front of the target block (data). An operation of moving the head to the target location is performed in order to write and read the data in and from the physical tape.

The error information includes an item for retries of reading. The item for retries of reading is information that is a value that is incremented by one when an error of reading the target block (data) written in the physical tape occurs and is eliminated by a retry (error retry) of reading the target block (data) written in the physical tape. The recall controller 201 (illustrated in FIG. 2) reads, from the cartridge memories for all the physical tapes included in the tape library devices 102, the numbers of the aforementioned various types of error retries performed on all the physical tapes included in the tape library devices 102. Then, the recall controller 201 stores the numbers of the error retries in the error retry number table storage unit 204.

When a physical tape is installed in any of the tape library devices 102, the recall controller 201 accesses the interested cartridge memory included in the tape cartridge 111 for the physical tape from the PLP 108 through the library controller 209 included in the interested tape library device 102. Then, the recall controller 201 reads the numbers (stored in the cartridge memory) of the various types (illustrated in FIG. 15 as the example) of retries from the cartridge memory, and develops, as initial values, the read numbers into the error retry number table stored in the error retry number table storage unit 204.

Next, the recall controller 201 performs the recall process on a certain physical tape. After that, the recall controller 201 accesses the cartridge memory for the certain physical tape from the PLP 108 through the library controller included in the interested tape library device 102. Then, the recall controller 201 reads the numbers (stored in the cartridge memory) of the various types (illustrated in FIG. 15 as the example) of retries from the cartridge memory, and develops, as recalled values, the read numbers into the error retry number table.

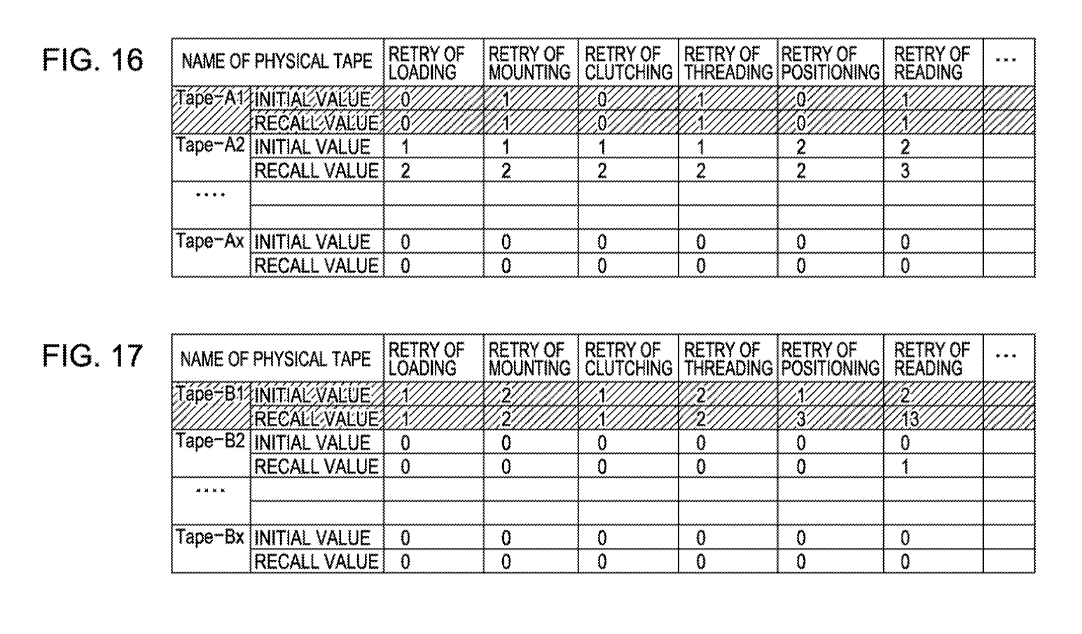

FIG. 16 is a diagram illustrating an example of the configuration of data stored in an error retry number table for the tape library device 102 #0, while FIG. 17 is a diagram illustrating an example of the configuration of data stored in an error retry number table for the tape library device 102 #1. Initial values are registered in each of the error retry number tables only when a physical tape is installed in any of interested tape library device 102. Thus, the initial values are registered only once for each of the physical tapes. In this case, when the physical tape is installed, recall values that are equal to the initial values are registered. However, recall values are rewritten and registered every time the recall process is performed on the interested physical tape.

The differences between the recall values of the interested physical tape and the initial values of the interested physical tape are referenced from the error retry number table during the recall process. Thus, the numbers of the various types of retries that are performed after the interested physical tape is installed in the tape library device 102 may be detected. When the differences between the recall values and initial values of the numbers of the various types of retries are large, it means that many errors that are related to the interested physical tape have occurred. Thus, it may be determined that the recall process should not be performed on the interested physical tape.

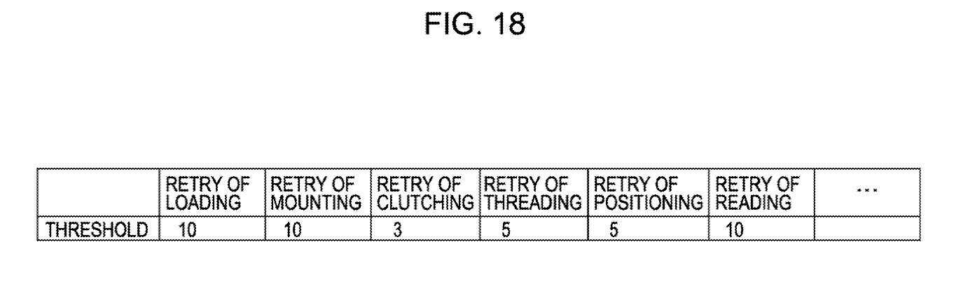

The error determining unit 205 (illustrated in FIG. 2) performs the following control operation. That is, the error determining unit 205 first holds a threshold table that has, stored therein, a threshold for each of the numbers of the various types of retries, as illustrated in FIG. 18. Then, the error determining unit 205 references an error retry number table for a physical tape in accordance with a recall instruction. Then, the error determining unit 205 determines whether or not the difference between a recall value and initial value of each of the various types of retries is equal to or larger than an interested threshold stored in the threshold table. As a result, when the difference between the recall value and initial value of at least one of the various types of retries is equal to or larger than the interested threshold, the error determining unit 205 determines that the interested physical tape may not be selected.

For example, according to the error retry number table illustrated in FIG. 16 as the example, the differences between the recall values and the initial values for the physical tape of the tape cartridge Tape-A1 are zero (and the number of retries after the physical tape of the tape cartridge Tape-A1 is installed is zero) and smaller than the thresholds. Thus, the physical tape of the tape cartridge Tape-A1 may be selected as a physical tape to be subjected to the selection and determination process to be performed by the physical tape selecting and determining unit 206 on the basis of the “time period required to start reading” (described above).

For example, according to the error retry number table illustrated in FIG. 17 as the example, a value that is obtained by subtracting an initial value of the item (for retries of reading) for the physical tape of the tape cartridge Tape-B1 from a recall value of the item (for retries of reading) for the physical tape of the tape cartridge Tape-B1 is 11. When this differential value (=11) is compared with the threshold (=10) (stored in the threshold table) for retries of reading, it is apparent that the differential value is larger than the threshold. Thus, the physical tape of the tape cartridge Tape-B1 is not selected as a physical tape to be subjected to the selection and determination process to be performed by the physical tape selecting and determining unit 206 on the basis of the “time period required to start reading” (described above). Specifically, the maximum value (for example, 9999) is set by the physical tape selecting and determining unit 206 as the “time period required to start reading” data from the physical tape of the tape cartridge Tape-B1.

When the physical tape selecting and determining unit 206 performs the selection and determination process on the physical tapes of the tape cartridges Tape-A1 and Tape-B1 on the basis of the “time periods required to start reading”, the following results are obtained.

<Time Period Required To Start Reading>

(The “time period required to start reading” data from the physical tape of the tape cartridge Tape-A1)=Time-1-A1 (Robot movement time period)+Time-2-A1 (Time positioning time period)

(The “time period required to start reading” data from the physical tape of the tape cartridge Tape-B1)=The maximum value (for example, 9999)

<Selection and Determination Process>

When the “time period required to start reading” the data from the physical tape of the tape cartridge Tape-A1 is compared with the “time period required to start reading” the data from the physical tape of the tape cartridge Tape-B1, a physical tape that corresponds to a shorter “time period required to start reading” is selected from among the physical tapes. For example, the physical tapes of the tape cartridges Tape-A1 and Tape-B1 are compared as follows.

(The “time period required to start reading” the data from the physical tape of the tape cartridge Tape-A1)≦(The “time period required to start reading” the data from the physical tape of the tape cartridge Tape-B1)

The above determination result is obtained, and the physical tape of the tape cartridge Tape-A1 is selected. The recall process starts to be performed on the physical tape of the tape cartridge Tape-A1.

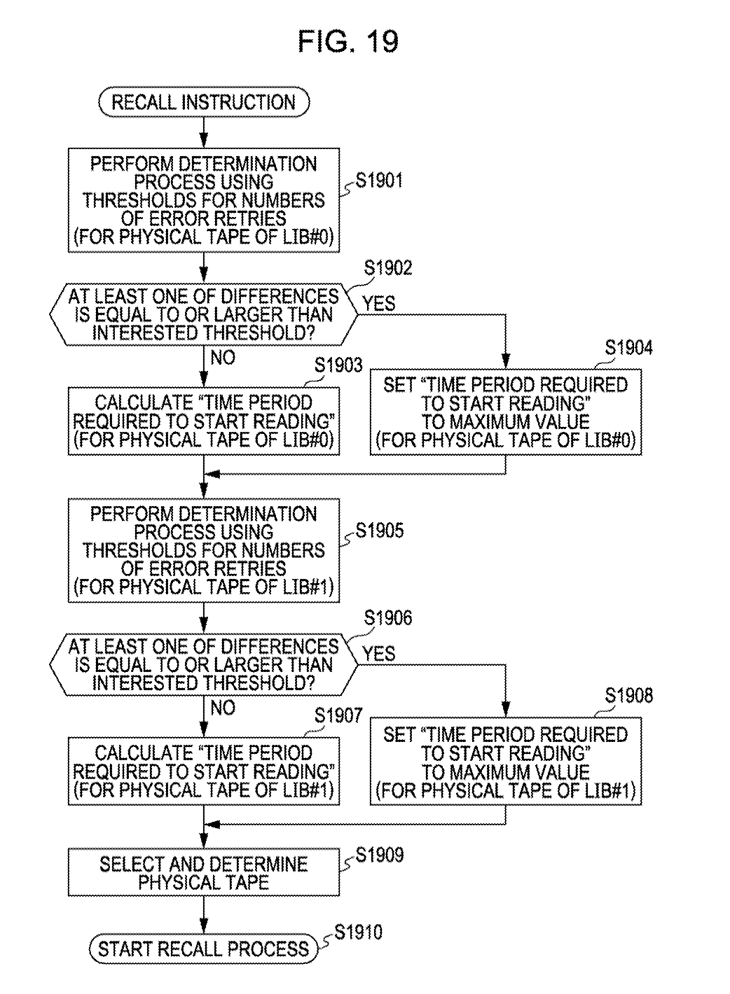

FIG. 19 is a flowchart of a process to be performed by the functions of the recall controller 201. The process illustrated in the flowchart of FIG. 19 starts when the recall instruction is issued in the VLP 106.

First, the error determining unit 205 (illustrated in FIG. 2) performs the process of determining whether or not the differences between recall values of the numbers of the various types of retries and initial values of the numbers of the various types of retries are equal to or larger than the interested thresholds (stored in the threshold table) for a physical tape on which a logical volume to be recalled exists and that is installed in the tape library device 102 #0 (indicated by LIB #0 in FIG. 19) (in step S1901).

When the difference between the recall value and initial value of at least one of the numbers of the various types of retries is equal to or larger than the interested threshold, or when the result of the determination is affirmative (Yes) in step S1902, the “time period required to start reading” is not calculated and is set to the maximum value for the physical tape installed in the tape library device 102 #0 (in step S1904).

On the other hand, when the differences between the recall values and initial values of all the numbers of the various types of retries are smaller than the interested thresholds, or when the result of the determination is negative (No) in step S1902, the robot movement time period calculator 202 (illustrated in FIG. 2), the tape positioning time period calculator 203 (illustrated in FIG. 2) and the physical tape selecting and determining unit 206 (illustrated in FIG. 2) perform the process of calculating the “time period required to start reading” for the physical tape installed in the tape library device 102 #0 (in step S1903).

Next, the error determining unit 205 performs the process of determining whether or not the differences between recall values of the numbers of the various types of retries and initial values of the numbers of the various types of retries are equal to or larger than the interested thresholds (stored in the threshold table) for a physical tape on which the logical volume to be recalled exists and that is installed in the tape library device 102 #1 (indicated by LIB #1 in FIG. 19) (in step S1905).

When the difference between the recall value and initial value of at least one of the numbers of the various types of retries is equal to or larger than the interested threshold, or when the result of the determination is affirmative (Yes) in step S1904, the “time period required to start reading” is not calculated and is set to the maximum value for the physical tape installed in the tape library device 102 #1 (in step S1908).

On the other hand, when the differences between the recall values and initial values of all the numbers of the various types of retries are smaller than the interested thresholds, or when the result of the determination is negative (No) in step S1906, the robot movement time period calculator 202 (illustrated in FIG. 2), the tape positioning time period calculator 203 (illustrated in FIG. 2) and the physical tape selecting and determining unit 206 (illustrated in FIG. 2) perform the process of calculating the “time period required to start reading” for the physical tape installed in the tape library device 102 #1 (in step S1907).

After that, the physical tape selecting and determining unit 206 performs the process of selecting and determining a physical tape (in step S1909). In the process of selecting and determining a physical tape, the “time period required to start reading” the data from the physical tape installed in the tape library device 102 #0 is compared with the “time period required to start reading” the data from the physical tape installed in the tape library device 102 #1. As a result, among the physical tapes, a physical tape that corresponds to a shorter “time period required to start reading” is selected, and the recall process starts to be performed on the selected physical tape (in step S1910).

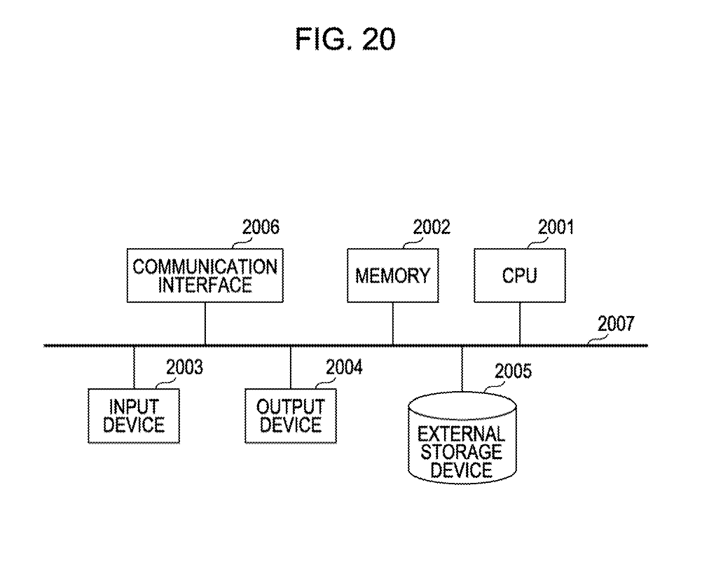

FIG. 20 is a diagram illustrating an example of a hardware configuration of the VLP 106 (illustrated in FIG. 2) that performs the process illustrated in the flowchart of FIG. 19. In the example illustrated in FIG. 20, the VLP 106 is configured as a computer. The computer illustrated in FIG. 20 includes a CPU 2001, a memory 2002, an input device 2003, an output device 2004, an external storage device 2005 and a network connection device 2006, which are connected to each other through a bus 2007. The computer that has the configuration illustrated in FIG. 20 is an example of a computer that may constitute a part of the aforementioned system. The computer is not limited to this configuration.

The CPU 2001 controls the entire computer. The memory 2002 is a memory (such as a RAM) that temporarily stores a program to be executed or data to be updated. The program and the data are stored in the external storage device 205. The CPU 2001 reads the program into the memory 2002 and executes the read program so as to control the entire computer.

The input device 2003 is constituted by a keyboard, a mouse or the like and an interface control device for the keyboard, the mouse or the like, for example. The input device 2003 detects an input operation performed by a user using the keyboard, the mouse or the like and notifies the CPU 2001 of the result of the detection.

The output device 2004 is constituted by a display device, a printing device or the like and an interface control device for the display device, the printing device or the like. The output device 2004 receives data transmitted by the control of the CPU 2001 and outputs the received data to the display device, the printing device or the like.

The external storage device 2005 is a hard disk device, for example. The external storage device 2005 is mainly used to store various types of data and the program. The network connection device 2007 is a device that is used to connect communication lines that are supported by interfaces included in the system illustrated in FIG. 1, for example.

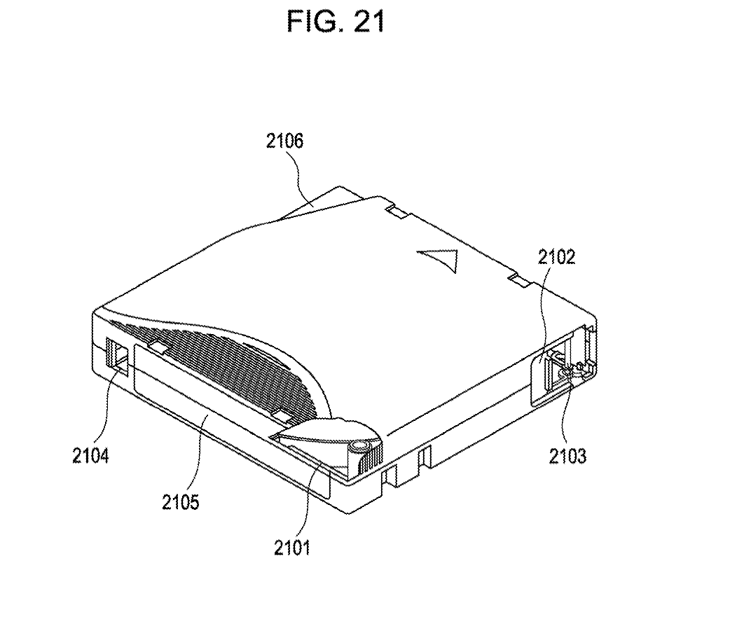

The system according to the present embodiment is configured by causing the CPU 2001 to execute the program that includes the functions that are necessary to perform the process illustrated in FIG. 19. FIG. 21 is a diagram illustrating an example of the configuration of the tape cartridge 111. The tape cartridge 111 includes a cartridge memory 2101, a cartridge door 2102, a leader pin 2103, a writing protection switch 2104, a label region 2105 and an insertion guide 2106.

The identification information on the tape cartridge 111 and the physical tape of the tape cartridge 111, and statistic information (numbers of error retries) on the use of the tape cartridge 111, are stored in the cartridge memory 111. Every time the tape cartridge 111 is unloaded, the drive 109 (refer to FIG. 2) writes related information in the cartridge memory 2101.

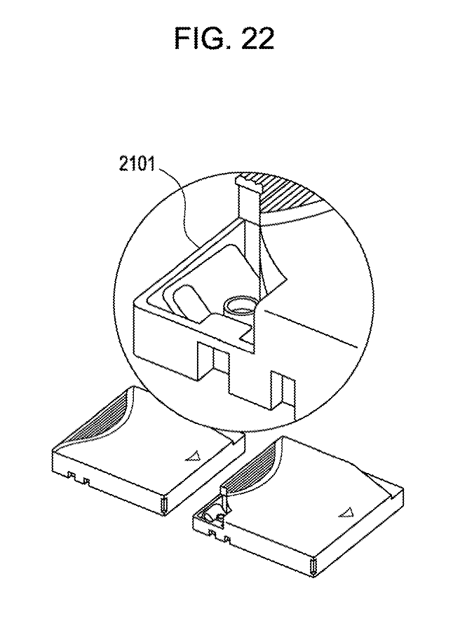

FIG. 22 is a diagram illustrating an example of the configuration of the cartridge memory 2101. An electrically erasable programmable ROM (EEPROM) chip that has a memory capacity of approximately 4 kilobytes to 8 kilobytes is embedded in an edge portion of the tape cartridge 111. The EEPROM chip may communicate with the interested library controller 209 and the like through the RF interface so that the information that is stored in the EEPROM chip is transmitted and received between the EEPROM chip and the interested library controller 209 and the like.

The cartridge door 2102 protects the physical tape so as to prevent the physical tape from becoming tainted when the tape cartridge 111 is carried out from the drive 109. The physical tape is connected to the leader pin 2103 on the inner side of the cartridge door 2102. When the tape cartridge 111 is inserted in the drive 109, the threading mechanism causes the leader pin 2103 (and the physical tape) to be extracted from the tape cartridge 111, pass through the drive head and reach the tape winding mechanism from which a tape may not be detached. Then, the head may read data from the physical tape and write data in the physical tape.

The writing protection switch 2104 protects the physical tape of the interested tape cartridge by preventing data from being written in the physical tape. The label region 2105 is a region on which a label is placed. Only a barcode label for reading of a volume is placed on and adheres to the label region 2105.

The insertion guide 2106 is a large notch region that prevents the tape cartridge from being inappropriately inserted in the drive. The embodiment describes that recall control is performed while a logical volume that is to be recalled is redundantly stored on physical tapes that are installed in cells 110 of the tape library devices 102 #0 and #1, respectively. However, the logical volume to be recalled may be redundantly stored in physical tapes that are stored in two cells 110 included in a single tape library device 102. In this case, the optimal physical volume may be selected by the functions of the recall controller 201 (illustrated in FIG. 2) according to the embodiment or in the process of the flowchart illustrated in FIG. 19.

In addition, the logical volume to be recalled may not be a single logical volume, and a plurality of logical volumes may be recalled. Furthermore, the number of logical volumes to be recalled is not limited to two. The number of logical volumes to be recalled is three or more. In this case, a physical tape that corresponds to the shortest “time period required to start reading” is selected.

In the present embodiment, the differences between the initial values and recall values of the numbers of the various types of retries are used for the determination to be made by the error determining unit 202 (illustrated in FIG. 2) or in error determination processes performed in steps S1901 and S1904 illustrated in FIG. 19. The numbers of the various types of retries may be the actual numbers of retries. In this case, the actual numbers of the retries are calculated without the initial values. In addition, the ratios of the numbers of the various types of retries to the number of times of access to an interested physical tape may be used for the determination.

In the present embodiment, the functions that constitute the recall controller 201 are performed as the functions that are included in the VLP 106 that constitutes a part of the virtual tape device 101. However, when the same functions may be performed, the functions of the recall controller 201 are not limited to the functions that are included in the VLP 106. For example, a part of the functions of the recall controller 201 may be included in at least one of the tape library devices 102.

According to a configuration disclosed herein and a method disclosed herein, when a recall instruction is issued, a physical tape from which data may be read more quickly may be selected from among the physical tapes from which data is to be recalled. Thus, it is possible to improve the access efficiency in the recall process.

As mentioned above, the present invention has been specifically described for better understanding of the embodiments thereof and the above description does not limit other aspects of the invention. Therefore, the present invention may be altered and modified in a variety of ways without departing from the gist and scope thereof.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present inventions have been described in detail, it should be understood that the various changes, substitutions, and alterations could be made hereto without departing from the spirit and scope of the invention.

What is claimed is:

1. A virtual tape device that is located between a host device and a tape library device and stores, as a virtual logical volume in a large scale storage device, data that has been transmitted and is to be received between the host device and the tape library device, the virtual tape device comprising:
a robot movement time period calculator that calculates, for each of physical tapes on which a target logical volume to be recalled exists, a time period in which a robot moves, from a cell to a drive device, the physical tape on which the target logical volume is to be stored in accordance with a recall instruction when the recall instruction is issued to recall the target logical volume redundantly stored on the physical tapes stored in two or more cells included in different tape library devices or in the same tape library device and to store the target logical volume in the large scale storage device;
a tape positioning time period calculator that calculates, for each of the physical tapes on which the target logical volume exists, a time period for tape positioning that is performed to read the target logical volume from the physical tape; and
a physical tape selecting and determining unit that calculates, for each of the physical tapes on which the target logical volume exists, a time period from the time when the recall instruction is issued to the time when the target logical volume starts to be read from the physical tape, on the basis of the time period in which the robot moves from the cell to the drive device and the time period for the tape positioning, and that selects, from among the physical tapes as a physical tape to be subjected to a recall process to be performed in accordance with the recall instruction, a physical tape that corresponds to the shortest time period from the time when the recall instruction is issued to the time when the target logical volume starts to be read from the physical tape.

2. The virtual tape device according to claim 1,
wherein the robot movement time period calculator calculates, for each of the physical tapes on which the target logical volume exists, the time period in which the robot moves the physical tape from the cell to the drive device, on the basis of information on the position of the robot located when the recall instruction is issued, information on the position of the cell in which the physical tape on which the target logical volume exists is stored, and information on the position of the drive device in which the physical tape on which the target logical volume exists is mounted.

3. The virtual tape device according to claim 1,
wherein when the recall instruction is issued, the tape positioning time period calculator references a logical-physical correspondence relationship information database storing correspondence relationships between logical volumes stored in the large-scale storage device and physical volumes stored on the physical tapes and acquires, for each of the physical tapes on which the target logical volume exists, information on the position of a region in which a data block of the target logical volume is stored on the physical tape on which the target logical volume exists, and the tape positioning time period calculator calculates, for each of the physical tapes on which the target logical volume exists, the time period for the tape positioning on the basis of the acquired information on the position of the region.

4. The virtual tape device according to claim 1, further comprising an error determining unit that determines, for each of the physical tapes on which the target logical volume exists, an error occurrence in the physical tape when the recall instruction is issued,
wherein the physical tape selecting and determining unit determines, for each of the physical tapes on which the target logical volume exists, whether or not the physical tape on which the target logical volume exists is selectable as the physical tape to be subjected to the recall process.

5. The virtual tape device according to claim 4, further comprising an error retry number table storage unit that stores information on occurrences of various types of error retries that are performed on all physical tapes installed in the tape library devices,
wherein when the recall instruction is issued, the error determining unit determines, for each of the physical tapes on which the target logical volume exists, an error occurrence in the physical tape by acquiring, from the error retry number table storage unit, information on occurrences of the various types of error retries performed on the physical tape.

6. A method for selecting a physical tape by a virtual tape device that is located between a host device and a tape library device and stores, as a virtual logical volume in a large-scale storage device, data that has been transmitted and is to be received between the host device and the tape library device, the method comprising:
calculating, for each of physical tapes on which a target logical volume to be recalled exists, a time period in which a robot moves, from a cell to a drive device, the physical tape on which the target logical volume is to be stored in accordance with a recall instruction when the recall instruction is issued to recall the target logical volume redundantly stored on the physical tapes stored in two or more cells included in different tape library devices or in the same tape library device and to store the target logical volume in the large-scale storage device;
calculating, for each of the physical tapes on which the target logical volume exists, a time period for tape positioning that is performed to read the target logical volume from the physical tape; and
calculating, for each of the physical tapes on which the target logical volume exists, a time period from the time when the recall instruction is issued to the time when the target logical volume starts to be read from the physical tape, on the basis of the time period in which the robot moves the physical tape from the cell to the drive device and the time period for the tape positioning, and selecting, from among the physical tapes as a physical tape to be subjected to a recall process to be performed in accordance with the recall instruction, a physical tape that corresponds to the shortest time period from the time when the recall instruction is issued to the time when the target logical volume starts to be read from the physical tape.

7. The method according to claim 6,
wherein the time period in which the robot moves the physical tape from the cell to the drive device is calculated for each of the physical tapes on which the target logical volume exists on the basis of information on the position of the robot located when the recall instruction is issued, information on the position of the cell in which the physical tape on which the target logical volume exists is stored, and information on the position of the drive device in which the physical tape on which the target logical volume exists is mounted.

8. The method according to claim 6,
wherein when the recall instruction is issued, the time period for the tape positioning is calculated for each of the physical tapes on which the target logical volume exists on the basis of information on the position of a region in which a data block of the target logical volume is stored on the physical tape.

9. The method according to claim 6, further comprising:
determining, for each of the physical tapes on which the target logical volume exists, an error occurrence in the physical tape when the recall instruction is issued; and
determining, for each of the physical tapes on which the target logical volume exists, whether or not the physical tape on which the target logical volume exists is selectable as the physical tape to be subjected to the recall process.

10. The method according to claim 6, further comprising:
storing information on occurrences of various types of retries that are performed on all physical tapes installed in the tape library devices; and
determining, for each of the physical tapes on which the target logical volume exists, an error occurrence in the physical tape by acquiring, from an error retry number table, information on occurrences of the various types of retries performed on the physical tape, when the recall instruction is issued.
